(19) United States
(12) Patent Application Publication
(10) Pub. No.: US 2014/0265084 A1
(43) Pub. Date: Sep. 18, 2014

(54) CLAMPING AND SPREADING TOOL

(71) Applicant: Techtronic Power Tools Technology Limited, Tortola (VG)

(72) Inventors: Thomas Evatt, Six Mile, SC (US); Richard Davidian, Pickens, SC (US); Anthony Tocco, Easley, SC (US)

(73) Assignee: Techtronic Power Tools Technology Limited, Tortola (VG)

(21) Appl. No.: 14/193,168

(22) Filed: Feb. 28, 2014

Related U.S. Application Data
(60) Provisional application No. 61/792,634, filed on Mar. 15, 2013.

(51) Int. Cl. B25B 5/06; B25B 27/14; B25B 5/16

(52) U.S. Cl. CPC B25B 5/068; B25B 5/16; B25B 27/14
USPC 269/6; 29/239

(57) ABSTRACT

A tool for providing a clamping force and a spreading force in the opposite direction of the clamping force. The tool includes a handle assembly having a trigger and a bar supported by the handle assembly. The bar is configured to move relative to the handle assembly when the trigger is actuated, and the bar includes a slot spanning from a first end of the bar to a second end of the bar. An inner rod is received within the slot, and a detent mechanism selectively couples the inner rod to the bar. The inner rod is received within the first end and coupled to the bar to provide the clamping force when the trigger is actuated, and the inner rod is received within the second end and coupled to the bar to provide the spreading force when the trigger is actuated.

### CROSS-REFERENCE TO RELATED APPLICATIONS

This application claims the benefit of U.S. Provisional Patent Application No. 61/792,634, filed on Mar. 15, 2013, the contents of which are incorporated herein by reference.

### BACKGROUND

The present invention relates to tools and in particular a tool that functions as both a clamp and a spreader.

### SUMMARY

In one aspect, the invention provides a tool for providing a clamping force and a spreading force in the opposite direction of the clamping force. The tool includes a handle assembly having a trigger and a bar supported by the handle assembly. The bar is configured to move relative to the handle assembly when the trigger is actuated, and the bar includes a slot spanning from a first end of the bar to a second end of the bar. An inner rod is received within the slot, and a detent mechanism selectively couples the inner rod to the bar. The inner rod is received within the first end and coupled to the bar to provide the clamping force when the trigger is actuated, and the inner rod is received within the second end and coupled to the bar to provide the spreading force when the trigger is actuated.

In another aspect, the invention provides a tool including a handle assembly and a bar supported by the handle assembly. The bar is configured to move relative to the handle assembly. An inner rod is coupled to the bar and a detent mechanism is coupled to the bar and configured to selectively lock the inner rod to the bar. The inner rod is adjusted relative to the bar to vary a span of the tool.

In another aspect, the invention provides a hand tool including a handle assembly having a trigger and a bar supported by the handle assembly. The bar is configured to move relative to the handle assembly when the trigger is actuated. A telescoping inner rod is adjustably coupled to the bar to vary the span of the tool and to switch the tool from a clamping configuration to a spreading configuration.

Other aspects of the invention will become apparent by consideration of the detailed description and accompanying drawings.

### BRIEF DESCRIPTION OF THE DRAWINGS

FIG. 1 a perspective view of a combination clamp and spreader tool in a clamping configuration.

FIG. 2 is a partial perspective view of a detent mechanism of the combination clamp and spreader tool of FIG. 1.

FIG. 3A is a cross-sectional view of the detent mechanism of FIG. 2 in a locking, first position.

FIG. 3B is a cross-sectional view of the detent mechanism of FIG. 2 in a released, second position.

FIG. 4A is side view of the combination clamp and spreader tool of FIG. 1 in the clamping configuration with a first span.

FIG. 4B is a side view of the combination clamp and spreader tool of FIG. 1 in the clamping configuration with a second span.

FIG. 4C is a side view of the combination clamp and spreader tool of FIG. 1 in the clamping configuration with a third span.

FIG. 4D is a side view of the combination clamp and spreader tool of FIG. 1 in the clamping configuration with a fourth span.

FIG. 5 is a partial perspective view of the combination clamp and spreader tool of FIG. 1 illustrating an actuation assembly with part of a handle removed for clarity.

FIG. 6 is a side view of the combination clamp and spreader tool of FIG. 1 in the clamping configuration, clamping a workpiece.

FIG. 7 is a perspective view of the combination clamp and spreader tool of FIG. 1 in a spreading configuration.

FIG. 8A is a side view of the combination clamp and spreader tool of FIG. 1 in the spreading configuration with a first span.

FIG. 8B is a side view of the combination clamp and spreader tool of FIG. 1 in the spreading configuration with a second span.

FIG. 8C is a side view of the combination clamp and spreader tool of FIG. 1 in the spreading configuration with a third span.

FIG. 8D is a side view of the combination clamp and spreader tool of FIG. 1 in the spreading configuration with a fourth span.

FIG. 9 is a side view of the combination clamp and spreader tool of FIG. 1 in the spreading configuration, spreading a workpiece.

FIG. 10 is a partial perspective view of a detent mechanism of a combination clamp and spreader tool according to another embodiment of the invention.

FIG. 11A is a cross-sectional view of the detent mechanism of FIG. 10 in a locking, first position.

FIG. 11B is a cross-sectional view of the detent mechanism of FIG. 10 in a released, second position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

FIG. 1 illustrates a combination clamp and spreader tool 10 in a clamping configuration. The combination clamp and spreader tool 10 includes a handle assembly 14, a slidable bar 18, and an inner rod assembly 22. The handle assembly 14 includes a housing 26, formed of two mating shells 26A, 26B that define a first aperture 30 and a second aperture 34 when coupled together. The slidable bar 18 is supported by the handle assembly 14 and is inserted through the housing 26, passing through the first aperture 30 and second aperture 34. The slidable bar 18 includes a center slot 38 spanning from a first end 42 to a second end 46. The handle assembly 14 further includes an actuation assembly 50 having a trigger 54 and a release trigger 58 for controlling the movement of the slidable bar 18, the operation of which is explained below. A first jaw portion 62 is formed as part of the housing 26 and includes a first pad 66, made of an elastomer or other such material, defining a first engagement surface 70.

The inner rod assembly 22 includes a second jaw portion 74 coupled to an inner rod 78 with two pins 86 at a first end 82. The second jaw portion 74 includes a second pad 90 and a third pad 94, both similar to the first pad 42. The second pad 90 defines a second engagement surface 98 and the third pad 94 defines a third engagement surface 102. The first surface 70 and the second surface 98 are the working surfaces of the tool 10 when in the clamping configuration, shown in FIG. 1 (i.e., the actuation assembly 50 forces the first surface 70 and second surface 98 together). The first surface 70 and the third surface 102 are the working surfaces of the tool 10 when in a spreading configuration, shown in FIG. 7 (i.e., the actuation assembly 50 forces the first surface 70 and third surface 102 apart). The inner rod 78 is received by the center slot 38 of the slidable bar 18 from either the first end 42 for the clamping configuration or the second end 46 for the spreading configuration. The inner rod 78 is completely separable from the slidable bar 18. The inner rod 78 includes four slots 106 spaced along the inner rod 78 for adjusting the span of the combination clamp and spreader tool 10 while in either the clamping or spreading configuration (i.e., the adjustable inner rod is telescopically coupled to the slidable bar 18). The span of the combination clamp and spreader tool 10 is equal to the distance from the second jaw portion 74 of the inner rod assembly 22 to the second end 46 of the slidable bar 18 in clamping configuration or to the first end 42 of the slidable bar 18 in the spreading configuration.

The slidable bar 18 further includes a first detent mechanism 110 proximal to the first end 42 and a second detent mechanism 114 proximal to the second end 46 for selectively locking the inner rod 78 to the slidable bar 18 via the slots 106. The detent mechanisms 110, 114 each include two pivotable clips 118 mounted on each side of the slidable bar 18. FIG. 3A shows the clips 118 pivoted in a first, locking condition where a tab portion 122 of the clip 118 is inserted into the slot 106 of the inner rod 78. FIG. 3B shows the clips 118 pivoted to a second, released condition where the tab portion 122 of the clips 118 are removed from the slot 106, allowing the inner rod 78 to slide relative to the slidable bar 18. The clips 118 are moved from the lock position to the released position by, for example, a user depressing a lever portion 126 of the clips 118 toward the slidable bar 18. In some embodiments, the clips 118 are biased by a torsional spring (not shown) to the locked condition, while in others, the clips 118 are held in the locked condition by an interference fit with the slot 106.

FIGS. 10, 11A and 11B illustrate a detent mechanism 200 of a clamp and spreader tool according to another embodiment of the invention. The detent mechanism 200 includes a detent housing 204 coupled to the slidable bar 18 via fasteners 208. The detent mechanism 200 further includes a plunger 212 positioned partially within the detent housing 204. With reference to FIG. 11A, the plunger 212 includes a detent portion 216, and when the detent mechanism 200 is in a first, locked position, the detent portion 216 passes through a first aperture 220 in the slidable bar 18, through an aperture 224 of the inner rod 78, and into a second aperture 228 on the opposite side of the slidable bar 18. The aperture 224 of the inner rod 78 is similar to the slots 106 of the above-described embodiment, and multiple apertures 224 are spaced along the inner rod 78 to provide adjustable span. With the detent portion 216 inserted into the aperture 224, the inner rod 78 is fixed relative to the slidable bar 18. The plunger 212 further includes a plate 232 formed on the plunger 212 against which a spring 236 positioned within the detent housing 204, biases the detent portion 216 toward the inner rod 78. The detent mechanism 200 further includes a knob 240 fixedly attached to the plunger 212 via a pin 244. With reference to FIG. 11B, the knob 240 is graspable by a user to pull the plunger 212 partially out of the detent housing 204 while compressing the spring 236 and removing the detent portion 216 from the aperture 224 in a second, released position. In the second, released position, the inner rod 78 is free to slide relative to the slidable bar 18. When the knob 240 is released by the user, the spring 236 biases the detent portion 216 back toward the inner rod 78 and the inner rod 78 will continue to slide relative to the slidable bar 18 until the detent portion 216 of the plunger 212 is received into the next aperture 224. The detent mechanism 200 is proximal to both the first end 42 and the second end 46 of the slidable bar 18.

With reference to FIG. 4A, the span of the combination clamp and spreader tool 10 is thereby determined by adjustably locking the inner rod 78 to the slidable rod 18 by one of the detent mechanisms 110, 114 engaging a slot 106 on the inner rod 78. FIG. 4A illustrates the clamp and spreader tool 10 in the clamping configuration with a first span 130 defined from the second jaw portion 74 to the second end 46. The first span 130 corresponds to the detent mechanism 110 engaging the slot 106 closest to the second jaw portion 74. Similarly, FIG. 4B illustrates the clamp and spreader tool 10 in the clamping configuration with a second span 134. The second span 134 is larger than the first span 130. The second span 134 corresponds to the detent mechanism 110 engaging the next slot 106 along the inner rod 78. Increasing the span of the clamp and spreader tool 10 while in the clamping configuration allows for a larger workpiece to be placed between the first engagement surface 70 and second engagement surface 98. FIG. 4C illustrates the clamp and spreader tool 10 with a third span 138 and FIG. 4D illustrates a fourth span 142. The forth span 142 is larger than the third span 138, which is larger than the second span 134. Each span corresponds to the detent mechanism 110 locking the inner rod 78 to the slidable rod 18 at one of the four slots 106.

FIG. 5 illustrates the actuation assembly 50 operable to control the movement of the slidable bar 18. Portions of the handle 26 are illustrated as removed in FIG. 5 for clarity. The trigger 54 is actuated by a user to pivot about a pivot pin 146 and is coupled to a first set of gripping plates 150 biased against the trigger 54 by springs 154. When the trigger 54 is actuated, the first set of gripping plates 150 are forced to move against the bias of the springs 154, thereby causing the slidable bar 18 to incrementally move in an actuating direction defined from the first aperture 30 to the second aperture 34 and indicated by arrow 158. A second set of gripping plates 162, biased by springs 166 and coupled to the release trigger 58, prevents the movement of the slidable bar 18 in a direction opposite the actuation direction 158. The release trigger 58 is pivotable about a pivot pin 170 when actuated by a user to release and allow the slidable bar 18 to move in a direction opposite the actuation direction 158. When the release trigger 58 is actuated, the slidable bar 18 is free to be rapidly adjusted by the user. The actuation direction 158 of the slidable bar 18 is the same in both the clamping and the spreading configuration. FIG. 6 illustrates the tool 10 in the clamping configuration with the first span 130 and the first surface 70 and second surface 98 clamped together on a workpiece W.

FIG. 7 illustrates the combination clamp and spreader tool 10 in the spreading (i.e., jacking, or prying) configuration. The spreading configuration utilizes the inner rod assembly 22 inserted into the second end 46 of the center slot 38 in the slidable bar 18. To switch between the clamping and spreading configurations, the inner rod assembly 22 is completely removed from the slidable bar 18 by the user at one end 42, 46 and inserted into the other end 46, 42. When in the spreading configuration, the actuating assembly 50 still moves the slidable bar 18 in the actuation direction 158 as in the clamping configuration, but now the actuation direction provides a spreading or jacking force between the first surface 70 and the third surface 102.

Similar to in the clamping configuration, the clamp and spreader tool 10 has an adjustable span in the spreading configuration. FIG. 8A illustrates the combination clamp and spreader tool 10 in the spreading configuration with the first span 130. The first span 130 now corresponds to the detent mechanism 114 engaging the slot 106 closest to the second jaw portion 74. The first span 130 (FIG. 8A) in the spreading configuration is the same length as the first span 130 (FIG. 4A) in the clamping configuration. Similarly, FIG. 8B illustrates the tool 10 in the spreading configuration with the second span 134. FIG. 8C illustrates the clamp and spreader tool 10 in the spreading configuration with the third span 138 and FIG. 8D illustrates the fourth span 142. The inner rod assembly 22 is thereby adjustable via slots 106 and detent mechanisms 110, 114 to increase or decrease the span of the tool 10 in either the clamping or the spreading configuration. In some constructions, the slots 106 are not evenly spaced along the inner rod 78 to provide spans unevenly spaced apart in the clamping and spreading configurations. FIG. 9 illustrates the tool 10 in the spreading configuration with the first span 130 and the first surface 70 and third surface 102 forcing apart two workpieces W. In the spreading configuration, the tool 10 is additionally able to jack a workpiece off of a work surface by applying the spreading force between the workpiece and work surface.

In some constructions, the second jaw portion 74 only includes a single engagement surface and is rotatably coupled to the inner rod 78 so as to pivot the engagement surface when switching between the clamping and spreading configurations.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A tool for providing a clamping force and a spreading force, the spreading force in the opposite direction of the clamping force, the tool comprising:
a handle assembly including a trigger;
a bar supported by the handle assembly and configured to move relative to the handle assembly when the trigger is actuated, the bar including a slot spanning from a first end of the bar to a second end of the bar;
an inner rod received within the slot; and
a detent mechanism operable to selectively couple the inner rod to the bar;
wherein the inner rod is received within the first end and coupled to the bar to provide the clamping force when the trigger is actuated, and wherein the inner rod is received within the second end and coupled to the bar to provide the spreading force when the trigger is actuated.

2. The tool of claim 1, wherein the handle assembly includes a first jaw portion and the inner rod includes a second jaw portion.

3. The tool of claim 2, wherein the first jaw portion includes a first workpiece-engagement surface, and the second jaw portion includes a second workpiece-engagement surface and a third workpiece-engagement surface.

4. The tool of claim 3, wherein the first workpiece-engagement surface and the second workpiece-engagement surface are engaged when the tool is providing the clamping force.

5. The tool of claim 3, wherein the first workpiece-engagement surface and the third workpiece-engagement surface are engaged when the tool is providing the spreading force.

6. The tool of claim 2, wherein the first jaw portion includes a first workpiece-engagement surface and the second jaw portion includes a second workpiece-engagement surface, the second jaw portion rotatably coupled to the inner rod.

7. The tool of claim 1, wherein the inner rod is completely separable from the bar.

8. The tool of claim 1, wherein the detent mechanism includes a pivotable clip coupled to the bar, the pivotable clip configured to be at least partially received in a slot formed in the inner rod to selectively couple the inner rod to the bar.

9. The tool of claim 1, wherein the detent mechanism includes a biased plunger coupled to the bar, the biased plunger configured to be at least partially received in an aperture formed in the inner rod to selectively couple the inner rod to the bar.

10. The tool of claim 1, wherein the inner rod is adjustable relative to the bar to vary a span of the tool.

11. A tool comprising:
a handle assembly;
a bar supported by the handle assembly and configured to move relative to the handle assembly,
an inner rod coupled to the bar; and
a detent mechanism coupled to the bar and configured to selectively lock the inner rod to the bar;
wherein the inner rod is adjusted relative to the bar to vary a span of the tool.

12. The tool of claim 11, wherein the bar includes a slot spanning from a first end of the bar to a second end of the bar; the inner rod is received within the first end and coupled to the bar to provide a clamping force, and wherein the inner rod is received within the second end and coupled to the bar to provide a spreading force.

13. The tool of claim 12, wherein the span can be adjusted in both a clamping configuration and a spreading configuration.

14. The tool of claim 11, wherein the detent mechanism includes a pivotable clip coupled to the bar, the pivotable clip configured to be at least partially received in a slot formed in the inner rod to selectively couple the inner rod to the bar.

15. The tool of claim 11, wherein the detent mechanism includes a biased plunger coupled to the bar, the biased plunger configured to be at least partially received in an aperture formed in the inner rod to selectively couple the inner rod to the bar.

16. A hand tool comprising:
a handle assembly including a trigger;
a bar supported by the handle assembly and configured to move relative to the handle assembly when the trigger is actuated;
a telescoping inner rod adjustably coupled to the bar to vary the span of the tool and to switch the tool from a clamping configuration to a spreading configuration.

17. The hand tool of claim 16, wherein the telescoping inner rod is coupled to a first end of the bar in the clamping configuration and coupled to a second end of the bar in the spreading configuration.

18. The hand tool of claim 16, further including a detent mechanism operable to selectively lock the telescoping inner rod to the bar.

19. The hand tool of claim 16, wherein the handle assembly includes a first jaw portion and the telescoping inner rod includes a second jaw portion.

20. The hand tool of claim 16, wherein the telescoping inner rod is adjustable to provide at least four spans of the tool.
